(19) United States
(12) Patent Application Publication
(10) Pub. No.: US 2004/0073674 A1
(43) Pub. Date: Apr. 15, 2004

(54) Method and a server for allocating local area network resources to a terminal according to the type of terminal

(75) Inventors: Gerard Vergnaud, Franconyille (FR); Francis Pinault, Bois-Colombes (FR)

Correspondence Address: SUGHRUE MION, PLLC, Suite 800, 2100 Pennsylvania Avenue, N.W, Washington, DC, 20037-3213, US

(73) Assignee: ALCATEL

(21) Appl. No.: 10/647,255

(22) Filed: Aug. 26, 2003

(30) Foreign Application Priority Data
Sep. 5, 2002 (FR) 02 10 907

(51) Int. Cl. G06F 15/173; G06F 15/16

(52) U.S. Cl. 709/226; 709/227

(57) ABSTRACT

A processing server (10) allocates user terminals (8) resources of a local area network (WLAN). The server (10) is connected to at least one access point (1) to the local area network (WLAN) and includes control means (11) adapted, firstly, to classify the terminals (8) in a first group or a second group according to whether or not they are adapted to establish with said local area network (WLAN) communications encrypted in accordance with at least one format and, secondly, to allocate resources of the local area network (WLAN) to terminals (8) attempting to establish communication therewith as a function of whether they are classified in said first group or said second group.

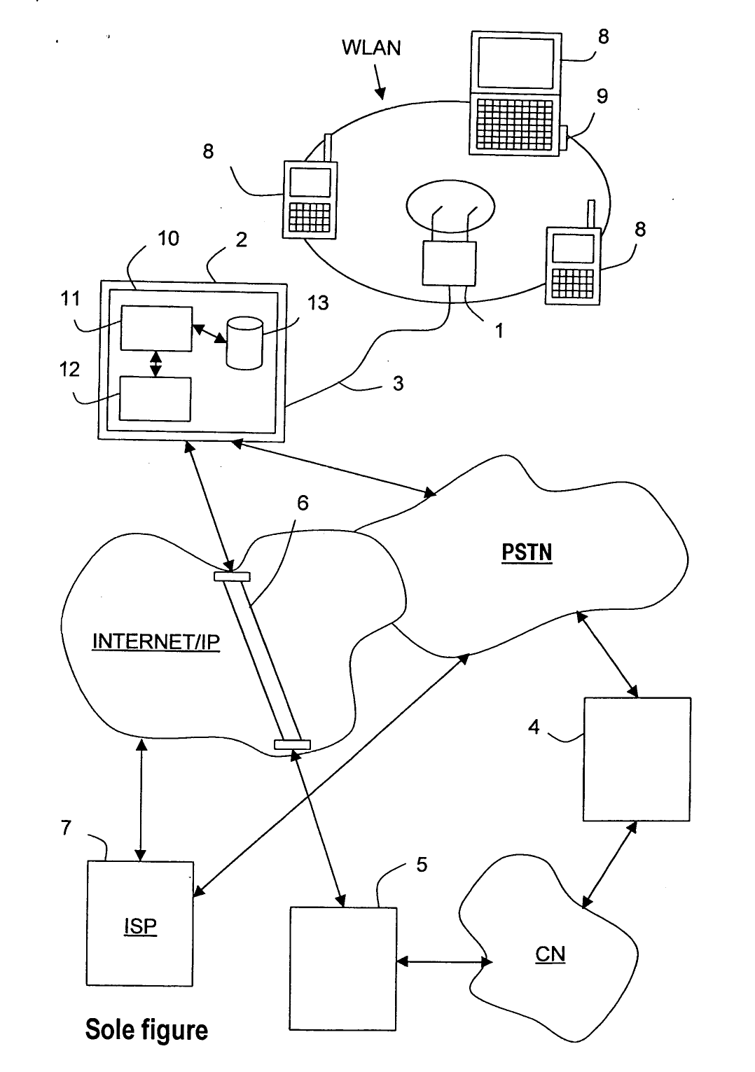

The field of the invention is that of communication between terminals within networks, and more particularly that of allocating local area network resources to terminals.

Many public and private sector organizations and many companies and company groups use wired local area networks (LAN) and wireless local area networks (WLAN). These local area networks provide access to local information to persons (users) who connect to a network access point, e.g. a terminal equipped with a fixed or removable LAN or WLAN card.

However, some local area networks also allow approved users to access other communication networks, for example Internet/IP type public data networks and/or public switched telephone networks (PSTN).

In some cases it is even possible to connect a local area network to a private network via a public network. In this case, the local area network generally belongs to the proprietor of the private network to which it is connected. When the proprietor is a company, this provides persons that it has approved, who are generally some of its employees, with remote access to the terminals of the company network, and thus to some of its data, and in some cases to services made available within the company network. However, to secure the data of the company, this facility can be used only by persons having a terminal configured to communicate with the local area network and the company network while using encryption in a chosen format.

Because only a small number of persons can use the local area network resources dedicated to connections to remote networks, whether these are private networks, data networks, or telephone networks, the resources are generally underused, although many other persons present in their coverage area could benefit from them.

Accordingly, an object of the invention is to remedy this drawback.

To this end it proposes a processing server which is dedicated to allocating local area network resources to user terminals and is adapted to be connected to at least one local area network access point by wire (for example by an Ethernet link) or by wireless (for example by an 802.11 b radio link).

The server is characterized in that it includes control means adapted, firstly, to classify the terminals attempting to establish communication with the local area network into a first group or a second group according to whether or not communications are encrypted in compliance with at least one format and, secondly, to allocate resources of the local area network to terminals attempting to establish communication therewith as a function of whether they are classified in the first group or the second group.

The control means are advantageously adapted to determine the medium access control (MAC) address of each terminal attempting to establish communication with the local area network and the server advantageously includes means for allocating an IP address to the terminal having the MAC address determined in this way. The allocation means are preferably of the Dynamic Host Configuration Protocol (DHCP) type.

The server preferably further includes a memory for storing a table containing primary MAC addresses associated with first terminals adapted to exchange data frames encrypted in compliance with the chosen format. The table can also contain secondary MAC addresses associated with second terminals adapted to exchange unencrypted data frames.

The control means are then preferably adapted to determine if a MAC address extracted from a received frame is a primary or secondary MAC address. If it is, the control means send the allocation means a request to allocate the terminal corresponding to the primary or secondary MAC address a primary IP address adapted to enable it to set up a link with at least one first remote network and one second remote network. If not, the control means send the allocation means a request to allocate the terminal corresponding to the MAC address, referred to as the “third” terminal, a secondary IP address adapted to enable it to set up a connection with at least one second remote terminal.

The first terminals are preferably associated with the first remote network, which may be connected to at least one second remote network. For example, they are company terminals, such as portable microcomputers, issued to company employees. Also, the second terminals preferably belong to known users of the first remote network. For example, they are mobile telephones belonging to company employees or to persons associated with the company.

Each first remote network is advantageously selected from the group comprising private networks, IP data networks, and telephone networks (public switched telephone networks or otherwise), and each second remote network is preferably selected from the group comprising IP data networks and telephone networks (public switched telephone networks or otherwise).

According to another feature of the invention the control means can be adapted to allocate at least two priority levels for allocation of resources of the local area network according to whether communications are encrypted in accordance with the chosen format or not. To this end, it is advantageous if the MAC addresses in the table are stored in corresponding relationship to at least one priority level. For example, a first priority level is allocated to first terminals associated with primary MAC addresses and a second priority level is allocated to second terminals associated with secondary MAC addresses. The control means can also be adapted to allocate a third priority level for allocation of resources of the local area network, for example to third terminals that set up communications that are not encrypted and whose MAC address is not in the table. Other levels higher than the third level can also be envisaged, as a function of the requirements of the application.

The priority levels preferably apply at least to the bandwidth allocated to the terminals and the bandwidth can decrease from the first level to the third level, so that the first terminals are given preference. However, the control means can change dynamically the allocation of bandwidth (or any other priority level) taking account of the traffic (or of the available resources). Accordingly, when traffic is low, a second level can be replaced by a first level and a third level can be replaced by a second level, and when traffic is very low, a third level can be replaced by a first level. The opposite approach is equally possible when the traffic is very high, in which case a first level can be replaced by a second level, or even a third level, or a second level can be replaced by a third level.

However, the priority levels can equally apply to rights of access to local or remote databases, and in particular to rights of access to audio and/or video data, for example in the context of video on demand applications, or to rights of access to physical resources, such as a dedicated terminals or printers.

For example, a server of the invention can be integrated into a router in order to mask the addressing plan of the first remote network (for example a company private network). However, it can equally well be integrated into an access point.

The invention also provides a communication installation including at least one local area network, for example a wireless local area network (WLAN), accessible via at least one access point, at least one first remote network, at least one second remote network, and a processing server of the kind defined above connected to at least one access point and to the first and second remote networks.

In this installation, the processing server is preferably connected to the first remote network via a virtual private network (VPN). However, it could instead be is connected to the first remote network via a remote access server (RAS).

The invention further provides a method of allocating resources of a local area network to user terminals via at least one access point to the local area network, which method consists in, firstly, in the case of an attempt at setting up a connection with the local area network by a terminal, classifying the terminal in a first group or a second group according to whether the connection is encrypted in accordance with at least one chosen format or not and, secondly, allocating resources of the local area network to the terminal as a function of whether it is classified in the first group or the second group.

In the event of an attempt by a terminal to set up a connection with the local area network, its MAC address is advantageously determined and an IP address is then allocated to the terminal having the MAC address determined in this way.

A table containing primary MAC addresses associated with first terminals adapted to exchange data frames encrypted in accordance with the chosen format is preferably provided and preferably also contains secondary MAC addresses associated with second terminals adapted to exchange unencrypted data frames.

When the above kind of table is present, the method can determine if a MAC address extracted from a received frame is a primary or secondary MAC address; if so, the terminal corresponding to that primary or secondary MAC address is allocated a primary IP address so that it can set up a connection with at least one first remote network and one second remote network; if not, the terminal corresponding to the MAC address, referred to as a third terminal, is allocated a secondary IP address so that it can set up a connection with a least one second remote network.

According to another feature of the invention at least two levels of priority for allocation of resources of the local area network can be allocated according to whether communications are encrypted in accordance with the chosen format or not. In this case, the MAC addresses in the table are advantageously stored in corresponding relationship to at least one priority level, whereby a first priority level can be allocated to first terminals associated with primary MAC addresses and a second priority level can be allocated to second terminals associated with secondary MAC addresses. The third terminals can be allocated a third level of priority for allocation of resources of the local area network.

The priority levels preferably relate at least to the bandwidth allocated to the terminals, which can decrease from the first level to the third level, for example. However, the allocation of bandwidth can equally well change dynamically, taking account of the traffic (or the available resources).

The invention can be implemented in public communication networks (PSTN and PLMN), and in particular in pubic mobile communication networks (GSM, GPRS, and UMTS networks) or private networks (PABX and residential gateways) able to use fixed wireless access, such as WLAN, Bluetooth or Ultra Wide Band (UWB) networks.

Other features and advantages of the invention will become apparent on reading the following detailed description and examining the single figure of the appended drawing, which shows diagrammatically one example of a communication installation equipped with a processing server of the invention. This figure is intended to contribute not only to describing the invention but also, where appropriate, to defining the invention.

The installation shown in the single figure includes a private company network CN, a wireless local area network WLAN belonging to a group of companies, for example, a public switched telephone network PSTN belonging to a telephone carrier, and a public data network Internet/IP.

The local area network WLAN has one or more access points 1 connected to an edge router 2 in turn connected to the public switched telephone network PSTN and to the public data network Internet/IP. In the example shown, the access point 1 is connected to the edge router 2 by a cable 3, preferably an Ethernet link. However, the connection could instead be a wireless connection, for example an 802.11 b radio link.

The company network CN is connected firstly to the public switched telephone network PSTN via a company server (or gateway) 4 and secondly to the edge router 2 via an IP router 5 having the proxy or firewall function and the public data network Internet/IP, preferably via a virtual private network (VPN) 6 which secures data by tunneling. A remote access server RAS, possibly coupled to a gateway type router, could be used instead of the VPN link.

Furthermore, the installation also includes one or more routers or gateways 7 of infrastructures which belong to Internet service providers ISP and each of which is connected to the public switched telephone network PSTN and to the public data network Internet/IP.

The local area network is preferably a wireless local area network (WLAN), a Bluetooth or Ultra Wide Band (UWB) network, or a cable local area network (LAN). Moreover, the company network CN is, for example, a private automatic branch exchange (PABX), possibly of the wireless type (conforming to the digital European cordless telecommunications (DECT) standard). Furthermore, although the telephone network is preferably a public switched telephone network (PSTN), it could instead be a public land mobile network (PLMN), such as a GSM, GPRS or UMTS network, for example. Of course, the invention is not limited to these types of network, or to the chosen number of networks. Thus there could co-exist a plurality of private networks each having access to one or more local area networks, a plurality of public data networks and a plurality of public switched telephone networks, or only to a plurality of public data networks and a plurality of public switched telephone networks.

The invention is intended to enable persons having access to a communication terminal 8 equipped with a removable or integrated LAN or WLAN card 9 to access one or more networks of the installation, referred to as remote networks, under conditions to be described later, when they are in the coverage area of a wireless local area network.

In the example shown, where the local area network is a wireless local area network, the communication terminals 8 are mobile telephones, portable microcomputers, or personal digital assistants (PDA), for example. Each communication terminal 8 has a medium access control (MAC) address (at level 2 of the ISO's OSI model), which is generally placed in the header of the data frames that it transmits.

Three types of communication terminal 8 are defined. A first type of terminal is a mobile terminal 8a that belongs to (or is associated with) the company to which the wireless local area network WLAN and the company network CN belong. In the case of a company, the terminals 8a are generally portable microcomputers fitted with a WLAN card 9 configured to enable exchange of encrypted data with one of the access points 1 of the WLAN using a first format and with the company network CN using a second format. The first and second formats are generally different, as it is usual for the access point itself to encrypt data frames received from a terminal 8a using an algorithm and a key supplied to it by the manager of the company network CN. The MAC addresses of the terminals 8a, which are referred to as primary terminals, are also known to the company and stored in a server of the company network CN.

A second type of terminal is a mobile terminal 8b that generally belongs to an employee of the company or outside persons working for the company, for example consultants. The terminals 8b are generally mobile telephones fitted with a fixed WLAN card. However, this card is not configured to enable the exchange of encrypted data with one of the access points 1 of the WLAN or with the company network CN. The MAC addresses of the terminals 8b, which are referred to as secondary terminals, are nevertheless known to the company and stored in the server of the company network CN previously referred to.

A third type of terminal is a mobile terminal 8c that belong to a person outside the company. The terminals 8c are mobile telephones, personal digital assistants, or microcomputers, fitted with a WLAN card. However, the card is not configured to enable the exchange of encrypted data with one of the access points 1 of the wireless local area network WLAN or with the company network CN. The MAC addresses of the terminals 8c, which are referred to as tertiary terminals, are unknown to the company.

A processing server 10 is provided, preferably in the edge router 2, to enable the terminals 8(a-c) to access some or all of the networks of the installation, according to their type. This server could instead be provided in one of the access points of the wireless local area network.

When a terminal 8(a-c) is in the coverage area of the wireless local area network WLAN and wishes to set up a connection with a remote network of the installation, it transmits to the access point 1 a connection request in the form of a data frame containing its MAC address in its header. If the terminal is a first terminal 8a, the frames that it sends are already encrypted in accordance with a first format. On receiving the encrypted frame, the access point 1 determines or verifies the algorithm that it must apply to the encrypted frame using the key that was supplied to it by the manager of the company network CN to convert it into a frame encrypted in accordance with a second format.

It is important to note that this determination can be based on the content of the header of the frame, although this is not obligatory. In other words, the access point 1 does not necessarily have to determine or verify the algorithm that it must apply to the frames received from the data contained in those frames. Moreover, it is important to note that frames encrypted in accordance with the first format and the same frames unencrypted are processed by parallel processes.

Once the access point 1 has encrypted the frame in accordance with the second format, it forwards it to the processing server 2.

Otherwise, if the terminal is a second terminal 8b or a third terminal 8c, the frames that it sends are unencrypted. Consequently, as soon as the access point 1 receives frames from these terminals, it forwards them to the processing server 2.

The processing server 10 includes a control module 11 which analyses each data frame transmitted by the access point 1. To be more precise, the control module 11 determines if the frame is encrypted in accordance with the second format or not. If so, the control module 11 classifies the terminal that sent it in a first group corresponding to the first terminals 8a, which are authorized to access the company network CN and the public networks, in this example the public switched telephone network PSTN and the public data network Internet/IP. If not, it classifies the terminal that sent it in a second group corresponding to the second terminals 8b or the third terminals 8c, which are a priori authorized only to access the public networks, in this example the pubic switched telephone network PSTN and the public data network Internet/IP.

The control module 11 then assigns resources of the wireless local area network WLAN to the terminal, but without actually allocating them, and the terminal attempts to connect to the remote networks, as a function of whether it is classified in the first or the second group.

In a basic embodiment of the invention, processing continues with the transmission of instructions by the control module 11 to the access point 1 to which the terminal 8 that submitted the connection request is connected, including a request to allocate the terminal resources of a first or second type, depending on whether it is a first terminal 8a, a second terminal 8b, or a third terminal 8c. For example, the first terminals 8a are allocated a high bandwidth whereas the second terminals 8b and the third terminals 8c are allocated a low bandwidth. The first terminals 8a can then, in the conventional way, connect to any of the remote networks (company network CN, data network Internet/IP, or public switched telephone network PSTN), whereas the second terminals 8b and third terminals 8c can connect only to the public data network Internet/IP or the public switched telephone network PSTN, as if they were connected directly to the edge router 2.

However, the priority levels can relate to parameters other than the bandwidth, for example the right of access to local or remote databases, and in particular to stockmarket or weather databases, or to audio and/or video databases, for example in the context of video streaming or video on demand applications, or the right of access to physical resources such as dedicated terminals or printers.

In this basic embodiment of the invention, the processing effected by the processing server 10 therefore ceases at this stage.

However, the invention goes further than this. It proposes that the second terminals 8b, which generally belong to employees of the company, have the benefit of access to the company network CN, even though their terminals are not configured to transmit frames encrypted in accordance with the first format. To this end, the control module 11 is adapted to determine the MAC address contained in the header of the frame initially supplied to it by the access point 1, at the time of a connection request submitted by a terminal 8, and after determining whether the request was encrypted or not. Once this has been determined, the terminal 8 can send an IP address allocation request to the processing server 10. The latter includes an IP address allocation module 12 coupled to the control module 11, and preferably taking the form of a Dynamic Host Configuration Protocol (DHCP) server.

As the person skilled in the art knows, a DHCP allocation module automatically distributes an IP address to a terminal or an equipment unit that wishes to dialogue with equipment situated outside a local area network. It generally constitutes a superset of BOOTP. Unlike the Internet address, the IP address actually (i.e. physically) identifies a terminal. It generally consists of four numbers in the range [0-255] separated by full stops. An IP address and an Internet address are generally linked by a Domain Name System (DNS) server.

Once the allocation module 12 has allocated an IP address to the terminal 8 whose MAC address has been determined by the control module 11, the terminal can dialogue with equipment units in the remote networks, if it is an approved terminal.

The processing server 11 preferably includes a memory 13 storing a table containing primary MAC addresses associated with first terminals 8a and preferably containing secondary MAC addresses associated with second terminals 8b. This table is supplied by the manager of the company network CN, preferably via the VPN link 6. As a general rule, all management information for configuring the processing server 10 is transmitted by the manager of the company network CN, preferably via the VPN link 6.

The control module 11 can access the memory 13 to verify if the MAC address that it has determined in the header of the frame received is a primary MAC address, a secondary MAC address, or a tertiary MAC address if it belongs to a third terminal 8c whose MAC address is unknown.

If the MAC address of the terminal 8a or 8b is a primary or secondary MAC address, the control module 11 sends the allocation module 12 a request to allocate the terminal concerned a primary IP address (company IP address) to enable it to set up a link with one of the remote networks to which the local area network is connected via the edge router 2, including the company network CN. On the other hand, if the MAC address of the terminal 8c is a tertiary MAC address (in other words, if it is not in the table stored in the memory 13), the control module 11 sends the allocation module 12 a request to allocate the terminal in question a secondary IP address (non-company IP address) enabling it to set up a link with the Internet/IP network via the infrastructure 7 of its service provider or with the public switched telephone network PSTN, possibly via a telephone access server, and not with the company network CN, since it is not approved by the latter.

However, the control module 11 can also be adapted to allocate a plurality of WLAN resource allocation priority levels according to whether communications are encrypted in accordance with the second format or not. The objective is to give the first terminals 8a priority over the second terminals 8b and the second terminals 8b priority over the third terminals 8c.

To this end, each primary and secondary MAC address from the table is stored in corresponding relationship to a priority level. For example, the table can be divided into two parts, one containing primary MAC addresses associated with a first priority level and the other containing secondary MAC addresses associated with a second priority level. By a process of deduction, the third terminals 8c associated with an (unknown) tertiary MAC address are automatically allocated a third priority level.

The priority levels preferably relate at least to the bandwidth allocated to the terminals 8. For example, the bandwidth decreases from the first level to the third level to give first terminals 8a belonging to the company priority over second terminals 8b belonging to employees of the company or to persons associated therewith and to give second terminals 8b priority over third terminals 8c belonging to persons outside the company. The priority level that is allocated to a terminal 8 is communicated to the access point 1 which is the equipment unit of the wireless local area network WLAN responsible for allocating resources of that network.

Moreover, in order to take account of the conditions of use of the resources of the wireless local area network WLAN in real time, the control module 11 is preferably able to modify dynamically the priority level that it allocates to the terminal 8 on the basis of information contained in the address table. For example, if the control module 11 has allocated a second terminal 8b a second priority level (that corresponds to an intermediate bandwidth, for example), and the traffic on the wireless local area network WLAN is low or moderate (which corresponds to a large number of available resources), it can decide to change this second level into a first level (corresponding to the greatest bandwidth, for example). Under the same traffic conditions, the control module 11 could also decide to change a third priority level allocated to a third terminal 8c into a second level. Moreover, if the traffic of the wireless local area network WLAN is very low (which corresponds to a very large number of available resources), the control module 11 can decide to change a third priority level allocated to a third terminal 8c into a first level.

The opposite approach can also be envisaged. Indeed, it may happen that the traffic in a wireless local area network WLAN is very high and that it is not possible to satisfy the demands of all the terminals 8, including the first terminals 8a. Consequently, the control module 11 can be adapted to change a first priority level allocated to a first terminal 8a into a second level or even a third level (corresponding to the lowest bandwidth). Similarly, it can change a second priority level allocated to a second terminal 8b into a third level.

Instead of or in addition to this, defining user profiles associated with some of the MAC addresses from the table can be envisaged. Accordingly, when the control module recognizes an MAC address of this kind, it can command the access point to allocate the terminal having that MAC address resources corresponding to the associated profile.

A few examples of the operation of an installation of the invention are described next.

Once the control module 11 has determined the MAC address, and where applicable the associated priority level (or profile), and the allocation module 12 has allocated an IP address to the terminal 8, the latter can, if it is a first terminal 8a or a second terminal 8b of the microcomputer type, access in the conventional way either the company network CN via the proxy router 5 or the data network Internet/IP via the VPN link 6. The proxy router 5 generally prompts the terminal user to identify himself by entering his login name and his password. If the first terminal 8a or the second terminal 8b is a mobile telephone, it is conventionally routed to the company gateway server 4 in order to be connected to the public switched telephone network PSTN or directly to a terminal of an employee of the company (via the internal telephone network). If the calling user transmits only one name, his call can be processed by a company Domain Name System (DNS) server or by a company Lightweight Directory Access Protocol (LDAP) directory.

If the terminal is a third terminal 8c of the microcomputer type, it can conventionally access only the data network Internet/IP via the infrastructure 7 of its usual Internet service provider ISP. It can use its browser for this. During the phase of identification of the user of the third terminal 8c by the ISP, the latter can decide to change the secondary IP address previously allocated by the allocation module 12.

Finally, if the terminal is a third terminal 8c of the mobile telephone type, two options can be envisaged. If the telephone 8c is a GSM, GPRS or UMTS telephone with an integrated local directory, the edge router 2 allocates it a media-gateway type characteristic, for example in accordance with the IETF Media Gateway Control Protocol (MGCP), which enables it to access directly the public switched telephone network PSTN. If not, the call is routed by the edge router 2 to the infrastructure 7 of the user's Internet service provider ISP which processes it by conventional name conversion, connection to the public switched telephone network PSTN, and the like, for example.

The control module 11 and the allocation module 12 of the processing server 10 of the invention can take the form of electronic circuits, software (or data processing) modules, or a combination of circuits and software.

The invention also provides a method of allocating resources of a wireless local area network (WLAN) or a cable local area network (LAN) to user terminals 8 via at least one access point 1.

This can be done using the processing server 8 and the communication installation described hereinabove. The main and optional functions and sub-functions provided by the steps of the method being substantially identical to those provided by the various means constituting the processing server 10 and the installation, only the steps implementing the main functions of a method of the invention are summarized hereinafter.

In a method of the invention, when a terminal 8 attempts to set up a connection with the wireless local area network WLAN, it is, firstly, classified in a first group or a second group according to whether the link is encrypted in accordance with at least one chosen format or not and, secondly, allocated resources of the wireless local area network WLAN as a function of whether it is classified in the first group or the second group.

Preferably, when a terminal 8 attempts to set up a connection with the wireless local area network WLAN, its MAC address is determined and it is then allocated an IP address.

Moreover, in the presence of a MAC address table, it is possible to determine if the MAC address extracted from a received frame is a primary or secondary MAC address and, if so, to allocate the terminal 8(a, b) corresponding to that primary or secondary MAC address a primary IP address enabling it to set up a connection with at least one first remote network or at least one second remote network and, if not, to allocate the terminal 8c corresponding to the MAC address, referred to as a third terminal, a secondary IP address enabling it to set up a connection with at least one second remote network.

Furthermore, at least two priority levels for allocation of resources of the wireless local area network WLAN can be allocated according to whether communications are encrypted in the chosen format or not. In this case, it is advantageous if the MAC addresses in the table are stored in corresponding relationship to at least one priority level, in which case a first priority level can be allocated to first terminals 8a associated with primary MAC addresses and a second priority level can be allocated to second terminals 8b associated with secondary MAC addresses. A third priority level for allocation of local area network resources to third terminals 8c can also allocated.

Thanks to the invention, it is now possible for persons who have no a priori authorization to access remote networks connected to a cable local area network (LAN) or a wireless local area network (WLAN) nevertheless to access at least some of the remote networks, provided that the local area network concerned has sufficient resources available. Such access can be charged or free-of-charge. This significantly improves the mobility of the communication terminals. Moreover, it enables local area network proprietors to make access to data or telephone networks available to all potential users. Thus in areas that do not have good radio coverage, by installing a local area network of moderate cost, all users requiring to do so can connect to the network of their telephone carrier and even to the Internet.

Furthermore, the invention can define priority levels for allocating local area network resources, or even specific resource allocation profiles, regardless of the type of resource concerned, including physical resources such as printers or database access terminals.

The invention is not limited to the embodiments of a method, a server and an installation described hereinabove by way of example only, but encompasses all variants falling within the scope of the following claims that the person skilled in the art might envisage.

Thus in the foregoing description there are references to priority levels applying to bandwidths. However, the invention can apply to any other priority level relating to the modes of allocating resources of a local area network, and in particular physical resources such as printers and terminals providing access to databases of any type, in particular stockmarket and weather databases.

Moreover, an application of the invention to wireless local area networks (WLAN) has been described. However, the invention applies equally well to cable local area networks (LAN), Bluetooth and UWB local area networks.

Moreover, an installation in which the local area network belongs to a company or to a group of companies having a private network (or first remote network) connected to said local area network has been described. However, the invention relates equally well to local area networks that are not connected to private networks. In this case, the local area network can be connected only to one or more data networks (or first or second remote networks) and/or to one or more telephone networks (or first or second remote networks).

Furthermore, a company private network has been referred to, but the invention applies to any private network that is connected to a local area network via a processing server of the invention.

Finally, a processing server installed in a router has been described. However, the processing server can equally well be installed in an access point of the local area network.

What is claimed is:

1. A processing server (10) for allocating user terminals (8) resources of a local area network (WLAN), which server is adapted to be connected to at least one local area network access point (1) and is characterized in that it includes control means (11) adapted: i) to classify the terminals (8) into a first group or a second group according to whether or not they are adapted to establish with said local area network (WLAN) communications encrypted in accordance with at least one format and ii) to allocate resources of said local area network (WLAN) to terminals (8) attempting to establish communication therewith as a function of whether they are classified in said first group or said second group.

2. A server according to claim 1, characterized in that said control means (11) are adapted to determine the MAC address of each terminal (8) attempting to establish communication with said local area network (WLAN) and in that it includes means (12) for allocating an IP address to the terminal (8) having the MAC address determined in this way.

3. A server according to claim 2, characterized in that said allocation means (12) are of the DHCP type.

4. A server according to claim 2, characterized in that it includes a memory (13) for storing a table containing primary MAC addresses associated with first terminals (8a) adapted to exchange data frames encrypted in accordance with said format.

5. A server according to claim 4, characterized in that said table contains secondary MAC addresses associated with second terminals (8b) adapted to exchange unencrypted data frames.

6. A server according to claim 4, characterized in that said control means (11) are adapted to determine if a MAC address extracted from a received frame is a primary or secondary MAC address and, if so, to send the allocation means (12) a request to allocate the terminal (8b) corresponding to said primary or secondary MAC address a primary IP address so that it can set up a link with at least one first remote network and one second remote network and, if not, to send the allocation means (12) a request to allocate the terminal (8c) corresponding to said MAC address, referred to as a third terminal, a secondary IP address so that it can set up a connection with at least one second remote terminal.

7. A server according to claim 4, characterized in that said first terminals (8a) are associated with said first remote network.

8. A server according to claim 7, characterized in that said terminals (8b) belong to known users of said first remote network.

9. A server according to claim 6, characterized in that each first remote network is selected from the group comprising private networks, IP data networks, and public switched telephone networks (PSTN), and in that each second remote network is selected from the group comprising IP data networks and public switched telephone networks (PSTN).

10. A server according to claim 1, characterized in that said control means (11) are adapted to allocate at least two priority levels for allocation of resources of the local area network (WLAN) according to whether communications are encrypted in accordance with said chosen format or not.

11. A server according to claim 10, characterized in that the MAC addresses in said table are stored in corresponding relationship to at least one priority level.

12. A server according to claim 11, characterized in that said priority levels comprise at least one first priority level allocated to first terminals (8a) associated with primary MAC addresses and one second priority level allocated to second terminals (8b) associated with secondary MAC addresses.

13. A server according to claim 12, characterized in that said control means (11) are adapted to allocate a third priority level for allocation of resources of the local area network to said third terminals (8c) setting up communications not encrypted in accordance with said chosen format and whose MAC address is not in said table.

14. A server according to claim 11, characterized in that said priority levels apply at least to a bandwidth and said bandwidth decreases from the first level to the third level.

15. A server according to claim 14, characterized in that said control means (11) send said access point (1) data representative of said bandwidth assigned to a designated terminal (8) and said access point allocates the corresponding resources to said designated terminal.

16. A server according to claim 10, characterized in that said control means (11) are adapted to modify an allocated priority level as a function of the available resources of said local area network (WLAN).

17. A server according to claim 1, characterized in that it is adapted to be connected to said local area network (WLAN) by a cable connection (3).

18. A server according to claim 17, characterized in that said cable connection (3) is an Ethernet link.

19. A server according to claim 1, characterized in that it is adapted to be connected to said local area network (WLAN) by a radio link.

20. A server according to claim 19, characterized in said radio link is a 802.11b radio link.

21. A router (2), characterized in that it includes a processing server (10) according to any one of the preceding claims.

22. A local area network access point, characterized in that it includes a processing server (10) according to any one of claims 1 to 20.

23. A communication installation including at least one local area network (WLAN) accessible via at least one access point (1), at least one first remote network, and at least one second remote network, which installation is characterized in that it includes a processing server (10) according to any one of claims 1 to 20 connected to said access point (1) and to said first and second remote networks.

24. An installation according to claim 23, characterized in that said local area network (WLAN) is a wireless local area network.

25. An installation according to claim 23, characterized in that said processing server (10) is connected to said first remote network (CN) via a virtual private network (VPN).

26. An installation according to claim 23, characterized in that said processing server (10) is connected to said first remote network (CN) via a remote access server.

27. An installation according to claim 23, characterized in that each first remote network is chosen from the group comprising private networks, IP data networks, and public switched telephone networks (PSTN) and in that each second remote network is selected from the group comprising IP data networks and public switched telephone networks (PSTN).

28. A method of allocating resources of a local area network (WLAN) to user terminals (8) via at least one access point (1) to said local area network, which method is characterized in that it consists in: i) in the case of an attempt at setting up a connection with said local area network (WLAN) by a terminal (8), classifying said terminal in a first group or a second group according to whether said connection is encrypted in accordance with at least one format or not, and ii) allocating resources of said local area network (WLAN) to said terminal (8) as a function of whether it is classified in said first group or said second group.

29. A method according to claim 28, characterized in that in the event of an attempt by a terminal (8) to set up a connection with said local area network (WLAN), its MAC address is determined and an IP address is then allocated to the terminal having the MAC address determined in this way.

30. A method according to claim 29, characterized in that a table is provided containing primary MAC addresses associated with first terminals (8a) adapted to exchange data frames encrypted in accordance with said chosen format.

31. A method according to claim 30, characterized in that said table contains secondary MAC addresses associated with second terminals (8b) adapted to exchange unencrypted data frames.

32. A method according to claim 30, characterized in that it determines if a MAC address extracted from a received frame is a primary or secondary MAC address and, if so, it allocates the terminal (8a, 8b) corresponding to said primary or secondary MAC address a primary IP address so that it can set up a connection with at least one first remote network and one second remote network and, if not, it allocates the terminal (8c) corresponding to said MAC address, referred to as a third terminal, a secondary IP address so that it can set up a connection with a least one second remote network.

33. A method according to claim 30, characterized in that said first terminals (8a) are associated with said first remote network.

34. A method according to claim 33, characterized in that said second terminals (8b) belong to known users of said first remote network.

35. A method according to claim 32, characterized in that each first remote network is selected from the group comprising private networks, IP data networks, and public switched telephone networks (PSTN) and in that each second remote network is selected from the group comprising IP data networks and public switched telephone networks (PTSN).

36. A method according to claim 28, characterized in that at least two levels of priority for allocation of resources of the local area network are allocated according to whether communications are encrypted in accordance with said chosen format or not.

37. A method according to claim 36, characterized in that the MAC addresses in said table are stored in corresponding relationship to at least one priority level.

38. A method according to claim 37, characterized in that the priority levels comprise at least one first priority level allocated to first terminals (8a) associated with primary MAC addresses and at least one second priority level allocated to second terminals (8b) associated with secondary MAC addresses.

39. A method according to claim 38, characterized in that a third priority level for allocation of resources of the local area network is allocated to said third terminals (8c) setting up communications that are not encrypted in accordance said format and whose MAC address is not in said table.

40. A method according to claim 36, characterized in that said priority levels relate at least to a bandwidth and said bandwidth decreases from the first level to the third level.

41. A method according to claim 40, characterized in that said access point (1) is sent data representative of the bandwidth assigned to a designated terminal (8) and said access point (1) allocates the corresponding resources to said designated terminal.

42. A method according to claim 36, characterized in that an allocated priority level is modified as a function of the available resources of said local area network (WLAN).

43. Use of a method, a router, an access point, a processing server and an installation according to any one of the preceding claims in communication networks selected from the group comprising PSTN, PLMN and Internet (IP) public networks and PABX private networks and private communication gateways.

44. Use according to claim 43, characterized in that the PLMN public networks are mobile networks selected from the group comprising GSM, GPRS and UMTS networks.
